(19) United States
(12) Patent Application Publication
(10) Pub. No.: US 2022/0022071 A1
(43) Pub. Date: Jan. 20, 2022

(54) Devices for Communicating in a Wireless Communication Network and Methods for Operating and Testing the Devices

(71) Applicant: Fraunhofer-Gesellschaft zur Foerderung der angewandten Forschung e.V., Munich (DE)

(72) Inventors: Paul Simon Holt Leather, Berlin-Nikolassee (DE); Ramez Askar, Berlin (DE); Mathis Schmieder, Berlin (DE); Thomas Haustein, Berlin (DE)

(21) Appl. No.: 17/488,030

(22) Filed: Sep. 28, 2021

Related U.S. Application Data
(63) Continuation of application No. PCT/EP2020/058650, filed on Mar. 27, 2020.

(30) Foreign Application Priority Data
Mar. 29, 2019 (EP) 19166302.0
May 2, 2019 (EP) 19172249.5

(51) Int. Cl. H04W 24/08; H04B 7/06; H04B 7/0452

(52) U.S. Cl. CPC H04W 24/08; H04B 7/0452; H04B 7/0617

(57) ABSTRACT

A device is configured for transmitting a stimulating signal towards a transceiving device; for receiving a plurality of transmit beam patterns from the transceiving device; for selecting a corresponding transmit beam pattern from the plurality of transmit beam patterns; and for sending response information to the receiving device, the response information indicating the corresponding transmit beam pattern.

### CROSS-REFERENCE TO RELATED APPLICATIONS

This application is a continuation of copending International Application No. PCT/EP2020/058650, filed Mar. 27, 2020, which is incorporated herein by reference in its entirety, and additionally claims priority from European Applications Nos. EP 19166302.0, filed Mar. 29, 2019, and EP 19172249.5, filed May 2, 2019, which are all incorporated herein by reference in their entirety.

The present invention relates to devices for communicating in wireless communication networks and to methods for operating/testing such devices. The present invention further relates to localized beam sweeping/beam set selection.

### BACKGROUND OF THE INVENTION

In over-the-air (OTA) measurement procedures for Beam Correspondence (BC) the best beam is selected/determined by the system simulator (SS)/test equipment (TE). A beam correspondence look-up table (LUT) in a user equipment UE is preset by the manufacturer. However, such a LUT may be inaccurate.

Thus, there is a need to allow for precise beamforming.

### SUMMARY

An embodiment may have a device for communicating in a wireless communication network, the device having an antenna arrangement, the device being configured for beamforming a plurality of transmit beam patterns using the antenna arrangement; wherein the device is configured for receiving a wireless signal and for determining a corresponding beam pattern that corresponds to the wireless signal; selecting a subset from the plurality of transmit beam patterns, the subset including the corresponding beam pattern; and for forming the selected subset; and receiving a response information that indicates at least one transmit beam pattern of the selected subset; wherein the device is configured for using the indicated transmit beam pattern.

Another embodiment may have a device configured for transmitting a stimulating signal towards a transceiving device; receiving a plurality of transmit beam patterns from the transceiving device; selecting a corresponding beam pattern from the plurality of transmit beam patterns; and sending response information to the receiving device, the response information indicating the corresponding beam pattern.

According to another embodiment, a system may have: at least one device for communicating in a wireless communication network, the device having an antenna arrangement, the device being configured for beamforming a plurality of transmit beam patterns using the antenna arrangement; wherein the device is configured for receiving a wireless signal and for determining a corresponding beam pattern that corresponds to the wireless signal; selecting a subset from the plurality of transmit beam patterns, the subset including the corresponding beam pattern; and for forming the selected subset; and receiving a response information that indicates at least one transmit beam pattern of the selected subset; wherein the device is configured for using the indicated transmit beam pattern; and at least one device configured for transmitting a stimulating signal towards a transceiving device; receiving a plurality of transmit beam patterns from the transceiving device; selecting a corresponding beam pattern from the plurality of transmit beam patterns; and sending response information to the receiving device, the response information indicating the corresponding beam pattern.

According to another embodiment, a method for operating a device having an antenna arrangement, the device being configured for beamforming a plurality of transmit beam patterns using the antenna arrangement, may have the steps of: receiving a wireless signal and determining a corresponding beam pattern that corresponds to the wireless signal; selecting a subset from the plurality of transmit beam patterns, such that the subset includes a corresponding transmit beam pattern; and forming the selected subset; receiving a response information that indicates at least one transmit beam pattern of the selected subset; and using the indicated transmit beam pattern.

According to another embodiment, a method for testing or updating a device having an antenna arrangement may have the steps of: sending a stimulus signal to the device along a reception direction so as to stimulate the device to establish a link with a source of the stimulus signal; receiving, from the device, a plurality of transmit beam patterns; selecting at least one of the plurality of transmit beam patterns, the plurality including a corresponding transmit beam pattern being selected by the device as transmit beam pattern corresponding to the stimulus signal; transmitting, to the device, information indicating the selected at least one transmit beam pattern; and updating information of a memory of the device based on the information indicating the at least one selected transmit beam pattern.

According to another embodiment, a method for testing or updating a device having an antenna arrangement may have the steps of: sending a stimulus signal to the device along a reception direction so as to stimulate the device to establish a link with a source of the stimulus signal; receiving, from the device, a transmit beam pattern; report, to the device, a quality measure of the transmit beam pattern; selecting an area to be covered with during the testing and selecting a subset of beam patterns formable with the device so as to illuminate the area; forming the subset of beam patterns; and measuring the subset of beam patterns to evaluate the device.

The inventors have found that by updating the correspondence LUT, i.e., the selection of the best beam, deviations from the preset configuration and variations during lifetime of a device may be compensated.

According to an embodiment, a device for communicating in a wireless communication network, the device having an antenna arrangement, the device being configured for beamforming a plurality of transmit beam patterns using the antenna arrangement; wherein the device is configured for receiving a wireless signal and for determining a corresponding beam pattern that corresponds to the wireless signal; selecting a subset from the plurality of transmit beam patterns, the subset including the corresponding beam pattern; and for forming the selected subset; and receiving a response information that indicates at least one transmit beam pattern of the selected subset; wherein the device is configured for using the indicated transmit beam pattern. This allows for an external correction or adaption of the corresponding beam pattern. This information may be used once by the device and/or may be stored in the LUT for further use.

According to an embodiment, a device configured for transmitting a stimulating signal towards a transceiving device; for receiving a plurality of beam patterns from the transceiving device; for selecting a corresponding beam pattern from the plurality of beam patterns; and for sending response information to the receiving device, the response information indicating the corresponding beam pattern.

According to an embodiment, a system comprises at least one device configured for receiving the reception signal and at least one device configured for transmitting a stimulating signal. The system may be, for example, a measurement environment or a wireless communication network, e.g., a cell thereof.

According to an embodiment, a method for operating a device having an antenna arrangement, the device being configured for beamforming a plurality of beam patterns using the antenna arrangement, comprises: receiving a wireless signal and determining a corresponding beam pattern that corresponds to the wireless signal; selecting a subset from the plurality of transmit beam patterns, such that the subset comprises a corresponding transmit beam pattern; and forming the selected subset; receiving a response information that indicates at least one transmit beam pattern of the selected subset; and using the indicated transmit beam pattern.

According to an embodiment, a method for operating a device comprises transmitting a stimulating signal to a transceiving device; receiving a plurality of transmit beam patterns from the transceiving device; selecting at least one corresponding transmit beam pattern from the plurality of beam patterns; and sending response information to the transceiving device, the response information indicating at least one transmit beam pattern.

According to an embodiment, a method for testing or updating a device having an antenna arrangement comprises sending a stimulus signal to the device so as to stimulate the device to establish a link with a source of the stimulus signal along the reception direction; receiving, from the device, a plurality of transmit beam patterns; selecting at least one of the plurality of transmit beam patterns, the plurality comprising a corresponding beam pattern being selected by the device as transmit beam pattern corresponding to the stimulus signal; transmitting, to the device, information indicating the selected at least one transmit beam pattern; and updating information of a memory of the device based on the information indicating the at least one selected beam pattern.

### BRIEF DESCRIPTION OF THE DRAWINGS

Embodiments of the present invention will be detailed subsequently referring to the appended drawings, in which:

FIG. 1a shows a schematic block diagram of a system 100 according to an embodiment;

FIG. 1b shows a schematic perspective view illustrating a selection of a predefined number of beam patterns for a subset;

FIG. 2 shows a schematic flowchart of a method according to an embodiment for testing or updating a device;

FIG. 3 shows a schematic flowchart of a method according to an embodiment that may be used to operate a device;

FIG. 4 shows a schematic flowchart of a method according to an embodiment that may be implemented to operate another device; and

FIG. 5 a flow chart of a network assisted uplink beam sweeping procedure that may be used in embodiments.

### DETAILED DESCRIPTION OF THE INVENTION

Equal or equivalent elements or elements with equal or equivalent functionality are denoted in the following description by equal or equivalent reference numerals even if occurring in different figures.

In the following description, a plurality of details is set forth to provide a more thorough explanation of embodiments of the present invention. However, it will be apparent to those skilled in the art that embodiments of the present invention may be practiced without these specific details. In other instances, well known structures and devices are shown in block diagram form rather than in detail in order to avoid obscuring embodiments of the present invention. In addition, features of the different embodiments described hereinafter may be combined with each other, unless specifically noted otherwise.

Embodiments described here relate to beam patterns that are formed by a device. Such beam patterns may be transmission beam patterns and/or reception beam patterns, i.e., spatial patterns of directions for transmission and/or reception of a signal.

Each of such a beam pattern may comprise a main lobe and possibly one or more side lobes. Optionally, between two adjacent lobes, there may be arranged a so-called null.

Forming a beam pattern in connection with the embodiments described herein may relate to a static beam pattern but may also relate to a dynamic, i.e., sweeping beam pattern. A sweeping beam pattern may be understood as a constant or varying pattern that is moved in space or in frequency, for example, rotated or laterally shifted. Such a sweeping may allow to adjust a direction of lobes and/or nulls of the beam pattern.

Directions that are described in connection with present embodiments do not limit the scope of the embodiments to the narrow meaning of a direction, i.e., a single vector. The term direction is to be understood so as to also includes a set of dominant angular components which contribute significantly to the received signal at the place/location, area/zone or volume of a communication partner. This may be equivalent to a complex 3D receive beam pattern which collects and weights different incoming multi-path components into an effective receive antenna input signal. Therefore direction is not limited to one line, but may cover an aggregation of signals from direction collected by the receive pattern. A transmit strategy may select a transmit beam pattern which provides good signal power transfer from the transmitter to the targeted receiver/communication partner.

Devices described herein that may perform beamforming may comprise an antenna arrangement, the antenna arrangement having one or more antenna panels, wherein each antenna panel may comprise one or more antenna elements. That is, each antenna panel comprises an arrangement of radiating/receiving antenna elements such that such a panel or a subpanel thereof is able to perform a coherent beamforming. That is, for performing beamforming, a number of antenna elements grouped to antenna panels, a number of antenna panels and thus a number of antenna elements in total, may be arbitrary.

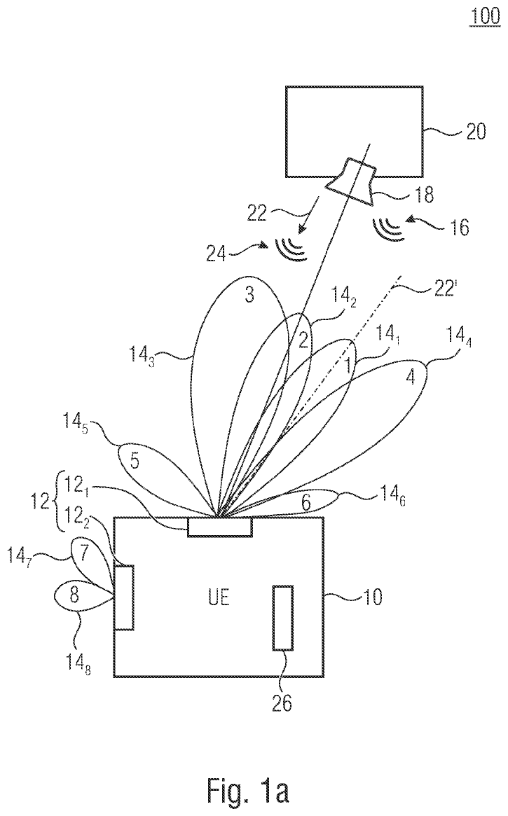

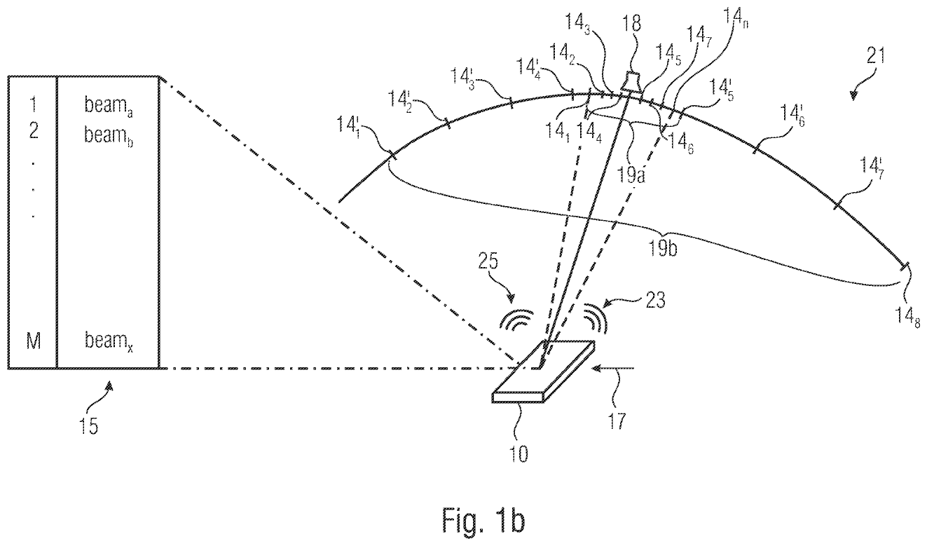

FIG. 1a shows a schematic block diagram of a system 100 according to an embodiment. System 100 comprising a device 10 and a device 20. The device 10 may be referred to as a user equipment but may relate to any device that comprises an antenna arrangement having one or more antenna panels 12₁ and/or 12₂ arranged on one or more sides of the device 10, wherein the antenna arrangement 12 and/or the panels 12₁ and 12₂ are configured to generate beam patterns 14. Examples may be stationary devices, mobile devices and/or satellites. Although each beam pattern 14₁ to 14₈ is depicted as having one single main lobe only, beam patterns may be formed independently from other beam patterns having a same or different number of main lobes and/or side lobes and/or nulls and be a transmit beam pattern or a reception beam pattern.

The device 20 may be, for example, a base station of a wireless communication network or may be, alternatively, a measurement equipment, e.g., a system simulator (SS) or test equipment (TE). Alternatively, the device 20 may be configured as another device 10, e.g., a UE or satellite, possibly when building up a peer-to-peer network or direct network that can operate without a base station. That is, the wireless communication network, may comprise several access points/base stations but is not needed to have a single thereof. A minimum case may be directed to two devices in communication with each other using the same mechanisms. This may be understood as using a forward link and reverse link for uplink and downlink, similar as it is used in the satellite world.

Embodiments, therefore also relate to a direct radio link access to satellites such that embodiments relate to satellite direct access or satellite backhaul as well.

The device 20 may be configured for transmitting a stimulus signal 16 using a link antenna 18 in a directed or undirected manner, wherein the device 10 receives the stimulus signal 16 as a reception signal or wireless signal. the device 10 may be configured for determining a reception direction 22 from which the reception signal 16 is received, i.e., an orientation with respect to the device 10 where a source of the signal 16 is estimated. A link antenna may comprise a fixed beam pattern under measurement conditions. As will be discussed, the device 20 may be implemented differently and optionally comprise an antenna arrangement capable of coherent beamforming.

That is, a downlink link antenna reference signal is provided to stimulate the device 10, e.g., the UE, to select an uplink beam in order to establish a link. Establishing a link to another device may relate to exchange data and/or signals and may comprise implicit or explicit estimation of the direction where the radio waves come from. For doing so, the device 10 may use a receive beam former and according to a metric applied on such receive beamformer the device 10 may decide on a suitable transmit beamformer to respond to the or answer to the communication partner. The selected beam pattern may be referred to as a corresponding beam pattern. Corresponding beam pattern may relate to a transmit beam pattern selected by the device 10 UE, possibly autonomously and/or based on the measured receive signal or any other metric/method.

The UE may select/provide (independently or with assistance) a corresponding uplink beam. For example, the device may be configured for selecting the corresponding beam pattern based on a metric comparing the reception signal with a plurality of predetermined values. That is, the UE can select the uplink beam based on a metric used to evaluate the received signals with different/a selection of receive beams, for example, mentioned as EIRP described herein. This may include use of one or more threshold values and ranges.

For example, if pattern reciprocity is given, then the transposed beam in baseband can be used to transmit with a pattern which corresponds to the best or selected best receive pattern. The corresponding beam pattern may be understood as a beam pattern that comprises a main direction that corresponds at least in the sense of a closest pattern to the reception direction and/or that is adapted for transferring radio signal power towards the location of the source where the incoming signal was transmitted from.

Based thereon, in an optimal or error-free environment, the beam pattern 14₂ is, by way of example, the beam pattern that may be generated with the antenna arrangement 12 so as to comprise a direction of a main lobe or side lobe or null along the reception direction, i.e., the beam pattern 14₂ may be the corresponding beam pattern in the error-free state.

According to various reasons, the device 10 may select the beam pattern 14₁ (or any other beam pattern) as the corresponding beam pattern. For example, the device may be configured to select the corresponding beam pattern based on a transmission power criteria such as an equivalent isotropically radiated power (EIRP). Details on EIRP are known from [6]. A reason for such a faulty decision may be a misalignment of at least parts of the antenna arrangement 12, deviations between positions of reception antennas and transmission antennas or interference along a transmission path. For example, a part of a human body, e.g., a hand or a head, may be arranged between the device 10 and the device 20 such that measurements and estimations of the device 10 are error prone and such that a wrong reception direction 22 is determined. As will be described herein, the determination of the device may be correct but there may exist different reasons to possibly select for a different beam pattern. It may be advantageous to receive a response information that allows the device 10 to select a beam pattern from more than one suitable beam patterns.

The device 10 is configured for selecting a subset from the plurality of beam patterns 14₁ to 14₈, the subset comprising the corresponding beam pattern that is selected by the UE, i.e., beam pattern 14₁ that matches the faulty reception direction 22′. The subset comprises at least one further beam pattern. The selection criteria for deciding whether a possible beam pattern 14₁ to 14₈ is part of the subset may be based on various parameters. A possible parameter is, for example, a transmission power towards a source of the reception signal 16. For example, the beam patterns 14₁, 14₂, 14₃ and 14₄ may be determined to have relevant transmission power along the faulty reception direction 22′. In contrast, beam patterns 14₅, 14₆, 14₇, and 14₈ may be determined to have none or at least no relevant transmission power along the reception direction 22′.

The additional beam patterns of the subset may be any other beam pattern that the device 10 may generate. For example, those beam patterns may exclude or include inflation or deflation of the same pattern by more or less power or/and having different weights (power and directions) on main and side lobes of such pattern. A selection of at least one beam pattern to be part of the subset may be such that after propagation of the signals through the radio channel, the received power at the other end is above a threshold or within a range or tolerance range, these transmit beam patterns provide overlapping coverage with the corresponding beam, i.e., the subset may comprise transmit beam patterns that provide for a reception in and around a direction within and around a volume/zone.

When referring again to the criteria according to which the subset is selected by the device 10, one possible parameter is a transmission power towards a source of the reception signal, i.e., device 20, being above a threshold value. An alternative or additional parameter may be a location of a covering range or covering area or covering volume or covering zone of the beam pattern with respect to the reception direction 22. In other words, the device 20, e.g., a base station or a measurement equipment (e.g., gNB, SS or TE) may request the UE to provide (select) a number of beams (subset or part of all possible beams which can be formed by the UE) that provide, according to an option 2, sufficient, i.e., predetermined link coverage in the direction of the link antenna in order to cover, according to an option 1, a spherical segment/zone in and/or around the reception direction 22. An area can be understood as a cut of a sphere or spherical segment. A Volume can be understood as a 3D area where the other communication partner is located, possibly including some space around it. This may be a kind of quite zone where the received power coming from the transmitted beam pattern is above a threshold/reasonably signal level. When considering an analogy of a torch: One can use all beams (make them part of the subset) which transfer enough light from the source (the transmitting device) to the destination (measurement/link antenna or gNB or another device somewhere located in 3D space).

The device 10 may form the selected subset of beam patterns. The beam patterns may be formed at a same time but are formed sequentially. For example, the device 10 may sequentially form the beam patterns 14₁ to 14₄. To allow discrimination of the beam patterns 14₁ to 14₄, the device 10 may be configured for labeling, marking or IDing each pattern of the subset individually. A way for IDing the beam patterns 14₁ to 14₄ may be a use of sounding reference symbols (SRS) resources that identify a specific beam pattern 14₁ to 14₄, i.e., the device 20 may determine which beam pattern is received and may discriminate between the different beam patterns of the subset. The device 20 thus receives one or more, advantageously all of the formed beam patterns of the subset. As the subset of beam patterns is labeled, the device 20 may identify the beam pattern that provides for a most promising link to the device 10, e.g., having the highest signal power when receiving the beam pattern.

The device 20 may be configured for selecting one of the beam patterns 14₁ to 14₄ from the subset, for example, based on the transmission power or any other suitable parameter. For example, a parameter that is associated with a most promising link quality, e.g., the signal power, may be used. That is, the device 20 may select the true corresponding beam pattern from the received subset. The device 20 may be configured for transmitting response information 24, e.g., a signal containing such information, to the device 10. The response information 24 may indicate the corresponding beam pattern selected by the device 20, which is the beam pattern 14₂ in the present example.

The device 10 may receive the response information 24 and may be configured for using the indicated beam pattern 14₂ as corresponding beam pattern. For example, the device 10 may establish a link to the device 20 using the beam pattern 14₂. Alternatively or in addition, the device 10 may update correspondence information being stored in a memory 26 of the device 10. The correspondence information may associate each of the plurality of beam patterns 14₁ to 14₈ with an associated reception direction 22. By updating the correspondence information, effects of a faulty or erroneous reception direction may at least be partially compensated. For example, the device 10 may vary a receive beam or may apply different receive beam patterns to select a fitting, corresponding transmit beam pattern. Based on the corrected or updated information, the device 10 may update the correspondence information.

Using the indicated beam may relate to different possible actions, including a combination thereof. For example, according to an option A: the transceiver/device 10 may follow the feedback such that the device is configured to use the indicated beam as the new corresponding beam when in similar situation. This may include measures to determine, what that situation is, e.g., using sensors or external information (location, environment, etc.). According to an option B: the transceiver/device 10 may follow the feedback so as to consider the indicated beam to be chosen in future as corresponding beam and updates the associated entry in the Lookup table (LUT). This provides for the advantage that device manufacturer still has full control about his algorithms and the device us unlikely to be fooled by faulty messages.

The device 10 may be configured, according to an option 3, for autonomously selecting and forming the subset of beam patterns. I.e., the device 10 receiving the stimulus signal 16 may select the subset responsive hereto. In other words, the UE (device 10) may autonomously provide (select) a number of beams (a subset of all possible beams which can be formed by the UE) that provide sufficient link coverage in the direction of the link antenna, i.e., reception direction 22.

As predetermined or sufficient link coverage one can understand that at least enough signal power is transmitted along the direction where the communication partner is. That is, the predetermined link coverage may be understood as a way so as to provide for at least sufficient signal power transferred into the direction and/or to the location of the user/communication partner and in the closer/local vicinity such that all members of the subset of beams allow reasonably communication/signal quality to be provided and some of them are suited to provide an even better signal depending on the instantaneous position of the device and the directivity of its receive antenna.

In each of the options 1, 2 and 3, forming the beam patterns of the subset may be performed automatically or autonomously. Forming the subset or at least parts thereof may be started or initiated automatically or responsive to a command or trigger. The command may be received from the communication partner, e.g., device 20, or from a protocol instance within the device. The trigger could be an event or and evolution of observed states from the receiver e.g. the receiver tracks the incoming radio signal and an algorithm concludes/decides that the use of another member of the selected subset would be more appropriate to be used at given state, point of time etc. In other words, the command may say what to do and when, the trigger may only activate another algorithmic loop or initiate a preconfigured action to be executed.

Alternatively or in addition, the beam patterns of the subset may be formed sequentially in an order indicated externally or determined by the device 10, in parallel, i.e., simultaneously, selectively, in superposition and/or on demand, wherein specifics of the respective option may be indicated by the command or the trigger.

Alternatively or in addition, the device 10 may be adapted so as to operate in a first operation mode. In the first operation mode, the device 10 is adapted to only select the corresponding beam pattern, e.g., the beam pattern 14₁. For example, this may be a regular operating mode in the field. In this mode, possibly no other beam patterns are formed for establishing the link. The device may be adapted to receive a request signal, possibly transmitted by the device 20, indicating a request to form the described subset. This request signal may instruct the device 10 to switch into a second mode in which the subset is formed, either after having formed only the single corresponding beam pattern 14₁ or as an alternative hereto. According to an embodiment, the information that makes the request signal indicating the request may be contained in the stimulus signal such that different types of stimulus signals 16 may lead to different reactions in the device 10. Alternatively or in addition, the device 10 may select between different modes. For example, when the stimulus signal 16 is received with a signal quality or signal power below a threshold, it may provide for the subset so as to obtain a chance to have a best possible beam pattern selected by the device 20.

The request signal or an additional request can request the device 10 to sweep or switch between the individual members, beam patterns, of the subset. Basically, this may be linked to beam IDing, that can advantageously be used in connection with embodiments to explicitly or implicitly activating the use of the additional beam subset in a certain mode or on request.

By externally checking the selected corresponding beam pattern for correctness or for checking of a better beam pattern in other ways, the device 10 may be updated and/or enabled to learn a new LUT in situ.

The named options 1, 2 and 3 provide for an extension of EIRP measurements (EIRP=equivalent isotopically radiated power). In connection with EIRP, the inventors have found that measurement requirements may relate to determining both minimum peak EIRP and spherical coverage. In such procedures, the UE may utilize uplink beam sweeping.

Several EIRP test procedures using uplink beam sweeping may be used, see [2]. As noted in [3], this method forms the baseline for conformance testing and was endorsed in the change request [4] to 3GPP TR 38.810. According to [3], in order to reduce test time, the SRS resource set used for uplink beam sweeping may be limited: “Upper limitation of SRS-Resource: to reduce the test time, the upper number of SRS-Resource (M) is 4, or 8 or 16 from TE.

According to the invention, it is discussed to: a) the baseline EIRP measurement procedure agreed in the WF [3]; b) the number of beams that comprise the uplink beam sweeping set and; c) the size of the SRS resource set.

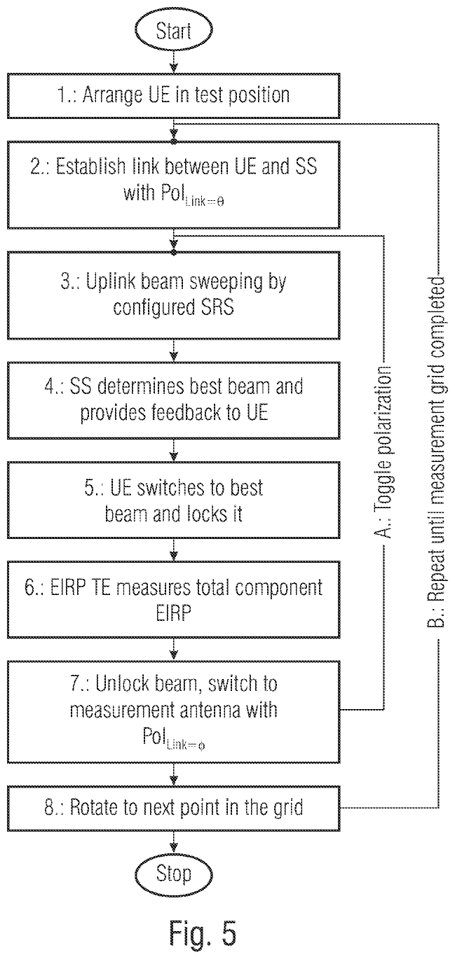

A flow chart of the network assisted uplink beam sweeping procedure [2] [4] is presented in FIG. 5 to which the following steps are referenced:
1. The UE is arranged in the test position.
2. For each point on the measurement grid, a link between the UE and the system simulator (SS) is established through the measurement antenna with PoI_{Link}=Θ.
3. The UE performs an uplink beam sweep with a set of configured reference signals (SRS) based on downlink reference signals.
4. The SS uses its own measurement capabilities to determine the power of all uplink sweeping beams. The identity of the “best beam” is returned to the UE.
5. The UE configures the “best beam” and enables beam lock.
6. The total component EIRP for both polarizations is determined using EIRP test equipment (TE), for example a spectrum analyser or a power meter.
7. [Loop A] The UE unlocks the beam. The SS switches to the measurement antenna with Pol_{Link}=ϕ Steps 3-6 are repeated once before moving to step 8.
8. [Loop B] Move to the next measurement point on the grid. Repeat steps 2 through 7 until all measurement points on the grid have been assessed.

Although the network assisted uplink beam sweeping procedure offers relatively short measurement times and reasonably good emulation of network performance, it relies on the ability of the SS to accurately assess the uplink. It should be noted that alternative methods offering higher accuracy at the expense of increased measurement time were proposed in [5].

Regardless of this, it is unclear whether the set of configured reference signals—those that define the uplink beam sweeps—is the same for each of the test points on the grid, or if a different set of beams is used for each test point.

In order to reliably determine EIRP, it is of advantage that the best beam—the uplink beam with the highest power in the direction of the link established with the SS or the EIRP TE (TE)—forms part of the set of swept beams. As the availability of the UE code book cannot be assumed at either the SS or the TE, the UE would have to sweep through all available beams in order that the best beam is not missed.

On the other hand, if the SS or TE were to have complete or partial knowledge of the UE code book, then the number of beams in the sweep set could be reduced. This would have the benefit of reducing measurement time in direct proportion to the size of the condensed set of SRS resources.

Observation 1: Without knowledge of the UE code book, every available beam has to be swept in order not to miss the best beam.

Observation 2: Equipping the SS or the TE with either complete or partial knowledge of the

UE code book will reduce test time in direct proportion to the size of the condensed set of SRS resources.

Proposal according to embodiments 1: Provide UE code book knowledge to the SS or the TE to enable intelligent SRS selection.

In the RAN4 #90 WF [3] it is stated that in order to reduce test time, the SRS-Resource (M) shall have an upper limit. Currently, values between four and sixteen are being discussed.

Observation 3: RAN4 has identified the benefit of limiting the SRS-Resource (M).

In view of the foregoing discussion, embodiments define that M, i.e., the number of distinguishable beam patterns and optionally the maximum size of the subset of beam patterns is selected or chosen in accordance to the antenna array dimensions (e.g. 4-by-n or 8-by-n) and in such a way that spherical coverage can be achieved using the resulting uplink beam sweep set. By way of example, the half power beam width (HPBW) of a 4-by-n and an 8-by-n array is approximately 26° and 13°, which would result in a beam set of about 64 and 256 beams, respectively. Without an adequately sized set of SRS-Resources, it cannot be ensured that the “best beam” is part of the resulting uplink sweep set.

Proposal according to embodiments 2: The size of the SRS resource set (M) shall be chosen in accordance with the antenna array dimensions.

For selecting the subset, the device may alternatively or in addition consider an operational parameter of the device. For example, the operational parameter may lead the device 10 so as to exclude a beam pattern from the plurality of beam patterns. E.g., for the sake of measurement reduction, the selected subset may be very small compared to all possible transmit beams a UE/device could form. For example, a small number is 4 or 8 out of 64 or 256 beam patterns.

As an example, the device 10 may only include those beam patterns into the subset that have a relevant or sufficient transmission characteristic to the device 20, or to include a predefined number that have the best characteristic. Alternatively or in addition, the device 10 may have knowledge that the corresponding beam pattern (although being possibly determined correctly) or a different beam pattern of the subset is currently unwanted or not allowed. This may be, for example, a location of a user of the device, e.g., a head thereof, such that the location of the user is excluded from the subset so as to avoid directing a maximum power of the device 10 towards the user. Any other criterion for excluding a specific beam pattern may be implemented. The device 10 may be configured for updating a look-up table indicating the plurality of beam patterns based on user interaction information indicating a use of the device by a user. For example, the device 10 may implement one or more sensors or input devices that indicate a user interaction. For example, a proximity sensor may indicate or sense the head of the user being at a side of the device 10 that comprises, for example, a microphone and/or a loudspeaker. Alternatively or in addition, the device 10 may sense a user's hand that holds the device. For example, the user interaction information may include holding the device in a hand, close to the head etc. and as a result certain beam patterns should not be used/excluded in order to meet SAR level requirements (SAR: Specific Absorption Rate).

That is, beam patterns may be excluded from the subset based on a known location such that the transmit beam patterns pointing towards those locations are excluded, for example, because of interference to other users, other devices or access points/base stations/eNBs/gNBs. For example, the device 10 may receive feedback relating to other device or receivers in space, e.g., other UEs or other gNB which indicate directly or indirectly to the device 10 their presence and/or request to remain undisturbed. For example, a device suffering from interference reports directly through a control channel to the device 10 or the serving gNB that it experiences unwanted interference power levels when the UE is using specific beam patterns. As a consequence the UE may decide not to use these beams on its own or in a coordinated manner e.g. in time slots when the other device does/would not suffer from such interfering beam. Alternatively, power back-off may be implemented as a further option.

Alternatively or in addition, the interfered device sends a response effectively inverting the interference channel on the resources it feels interfered. In this way the device causing the interference, i.e., device 10, is interfered as well and can adaptively avoid transmission into the direction(s) associated with the receive pattern which collected substantial signal power from the other device.

Embodiments thus allow for devices configured for updating a parameter setting relevant for an algorithm to determine the plurality of beam patterns based on user interaction information indicating a use of the device by a user. I.e., the device may learn that apart from the initial state, it may apply different beam patterns when being used by a user.

The device 10 may be configured for receiving the stimulus signal 16 and/or the response information 24 with the same antenna arrangement 12 that is adapted to form the beam patterns 14₁ to 14₈. Alternatively, the device 10 may comprise different antenna arrangements for receiving the signals 16 and 24 and for forming the beam patterns.

The subset is a strict subset of the plurality of beam patterns 14₁ to 14₈. That is, at least one of the possible beam patterns 14₁ to 14₈ is not contained in the selected subset. This may have the particular advantage that a time for selecting, evaluating or choosing the best beam pattern may be low as being reduced when compared to testing all of the beam patterns. Unnecessary measurement time, in particular in measurement environments, may be reduced by not selecting beam patterns as part of the subset that are known to be no suitable candidate for the corresponding beam pattern.

Although the system 100 is illustrated as having one device 10 and one device 20, the system 100 may comprise more than one device of type device 10 and/or more devices of type device 20.

Embodiments, that may be combined with other embodiments without limitation, address the selection of the subset of beam patterns. For example, operation during regular network operation and/or during measurement may be limited or rely on regulations. For example, the device 10 may be needed for performing at most or even exactly the predefined number of beam patterns as the subset. Such a number M may be any appropriate number, e.g., 5, 6, 8, 12 or a different or even higher number.

By way of example, the device 10 follows a requirement to provide the subset with at most M beam patterns. That is, in a case where the device 10 estimates a number of at most the predetermined number, i.e., M, as suitable for the subset, it forms the subset as described in connection with other embodiments described herein. Alternatively, the device 10 may include additional, possibly less suited or unsuited beam patterns into the subset so as to arrive at the predetermined number. E.g., the device 10 may be configured for selecting the subset 15 so as to comprise exactly the predefined number of beam patterns, the predefined number being M. A suitability may be associated, for example, with a radiated power that illuminates a specific area, e.g., a location of the link antenna 18.

FIG. 1b shows a schematic perspective view illustrating a selection of a predefined number of beam patterns for a subset. The predefined number M is, for example, 8 (or a different number) including the corresponding beam pattern Example values for M are 2, 4 8, 16 or any other number therebetween or above. The beam patterns 14₁ to 14₈ to be formed may be part of the subset 15 shown as “beamᵢ” with i being an index a, . . . , x, i.e., out of the i beam patterns that the device 10 may form, the subset 15 is a selection.

The selection may at least be influenced by reception of a signal 17 indicating that the respective mode is requested to be executed by the device 10. For example, the device 10 may be configured for selecting the subset 15 so as to comprise the predefined number M of beam patterns. The predefined number M may be considered as the minimum value of a number of beam patterns that the device 10 is capable to form, e.g., 1, 2, 3, 4 or a higher number such as 8, 16, 32, 48, 64, and the maximum number allowed from the system. E.g., when the number of beam patterns is lower than the maximum number allowed by the system (8 in the present example), the former may apply whilst in the opposing case, the latter applies. The device 10 may form the subset such that the number of beam patterns identified in the subset and/or subsequently formed by the device 10 is equal or less than the predefined number, i.e., the predefined number may limit the beam pattern count of the subset 15.

The beams of the subset 15 may be correlated to each other by a local variance of main directions of the beam patterns. For example, the device may be configured for selecting the subset such that the predefined number of beam patterns locally covers an area around the corresponding beam pattern as illustrated for beam patterns 14₁ to 14₈, i.e., the beam patterns 14₁ to 14₈ are selected so as to locally cover or illuminate the link antenna 18. E.g., the subset may comprise the predefined number of spatially closest beams to the link antenna with regard to the transmitted power. For example, the device may be configured for selecting the subset 15 such that the predefined number of beam patterns has a maximum density around the corresponding beam pattern.

Alternatively or in addition, the device may configured for selecting, e.g., subsequently or as an alternative mode, the subset 15 such that the predefined number of beam patterns are spread in a spreading area being at least a part of a sphere 21 comprising an area illuminated by the corresponding beam patterns as illustrated for beam patterns 14′₁ to 14′₈. When compared to a comparatively small area or section 19a of a sphere 21, i.e., a possible virtual projection plane, e.g., spanned by or evaluated by measurement equipment, an area or section, i.e., a spreading area 19b may be large. For example, the area 19b may be a full sphere or an area of interest thereof. A size of area 19b may be indicated, e.g., by use of signal 17 that may also be signal 16 or may be preset or determined by device 10. That is, the device may be configured for selecting a size of the spreading area 19b based on a static predefined value or based on a variable value received as part of a signal.

For example, the device 10 may be configured for selecting the subset 15 such that the predefined number is, within the capabilities of the device, uniformly distributed within the spreading area. That is, the beam patterns 14′₁ to 14′₈ (e.g., a location of a maximum or minimum radiated power or a different reference point of the beam pattern) may be uniformly or non-uniformly distributed along one or more directions of the sphere 21.

Alternatively or in addition, the device 10 may be configured for sending a signal 23 comprising a subset indication indicating that the subset comprises the predefined number. That is, the device 10 may indicate to other devices and/or measurement equipment or base stations that it only uses the subset 15 being limited to the predefined number. Alternatively or in addition the device may be configured for receiving a signal, e.g., signal 16 and/or 17 or a different signal comprising a subset request. The subset request may be a bit/flag or a sequence/plurality of bits contained in a signal or may be a dedicated signal and may indicate that the device 10 is requested to select the subset 15 so as to comprise the predefined number M. The device 10 may select the subset 15 so as to comprise the predefined number M based on the subset request.

Possibly, the device may once or repeatedly be unable to follow such a request. E.g., it may be unable to form the needed number of beam patterns, as some possible beam patterns are unallowed (at the moment), possibly because a location of a user is additionally to be excluded. The device 10 may be configured for determining that the requested actions exceed the capabilities of the device 10. The device 10 may send a response signal 25 indicating that the device 10 will not operate in accordance with the request. Alternatively or optionally the device 10 may be configured for transmitting the response signal 25 based on the request, the response signal 25 indicating that the device 10 will operate in accordance with the request, e.g., as a positive acknowledgement. The response signal 25 may also contain information by means of its presence or absence. That is, the absence may indicate a positive response or a negative response.

Whilst the device 10 may be requested to limit the number of beam patterns of the subset 15 and thus the number of formed beam patterns as a basis for the later selection, it may be appropriate to have more than the predetermined number of beam patterns, especially in view of measurement purposes. Imagine, for example, the number of 8 beam patterns being distributed along two directions of the sphere 21 and generated to cover a large or the largest possible beam coverage area of the sphere around the device 10. For such and others situations, the device 10 may generate a multitude or plurality of subsets, e.g., sequentially one after another, the different subsets having at least in parts different beam patterns. According to an embodiment, the subsets may even be non-overlapping or disjoint with regard to the selected beam patterns and/or the covered area.

Possibly one or more of the subsets may be selected so as to have no corresponding beam patterns. This may allow to cover a large spreading area 19b and/or to cover the spreading area 19b with a high density of beam patterns. For example, the device 10 may be configured for signaling information, e.g., using signal 25 or a different signal, indicating that a number of selected beam patterns considered as candidates for the subset 15 exceeds the predefined number M. This may be an indication that further subsets are possible/needed. The device 10 may receive a response to such a signal, indicating that the device 10 is requested to provide, i.e., select and form, additional subsets. The device 10 may thus receive a signal/a request to form at least a second subset and for selecting and forming at least the second subset comprising at least one different beam pattern when compared to the first subset of beam patterns.

By selecting different subsets, different, possibly partially overlapping areas of sphere 21 may be illuminated such that the subsets, the beam patterns thereof respectively cover at least partially a different area of a sphere 21 around the device 10.

In other words, due to the limited number of M beams provided by the DuT/UE the options to either cover the full or a substantial part of the sphere are limited and depending on the narrowness of the beams even local beam sweeping might not cover all possible/suitable beams around the direction towards the link antenna.

Therefore, further information exchange between the DuT and the ME/BS may be supported. The measurement equipment or measurement environment may also be a base station emulator or testing platform. In order to limit this exchange to be minimal embodiments provide for the following mechanism and associated implementation options:

Option A: Introduction of a flag/signal/bits that
A.1: allows a UE/device to signal that it is distributing its M beams marked/identified by SRS or SSB (i.e., distinguishable by sounding reference symbols) to cover the sphere or locally for localized beam sweeping.
A.2: allows the ME/BS to request the UE to distribute its M beams marked/identified by SRS or SSB to cover the sphere or locally for localized beam sweeping.

Having a number of beams around a given direction or covering a spherical area/zone/region of relevance/interest can be called a set of localized beams for sweeping.

Embodiments that may be alternatively or in addition be implemented are related to devices such as device 10 that are configured for selecting the subset 15 based on a preconfigured codebook/state/alphabet/LUT/register/list associating the corresponding beam pattern with at least one additional beam pattern.

The codebook/state/alphabet/LUT/register/list may associate the corresponding beam pattern with a number of beam patterns summing up together with the corresponding beam pattern to the predefined number of beam patterns such as a number of M as described. That is, for each corresponding beam pattern the subset 15 may be predefined or preset.

The device 10 may be configured for selecting the subset 15 using the codebook/state/alphabet/LUT/register/list based on a signal indicating a respective request, e.g., the signal 16 or 17. The device may be configured for transmitting a response signal, e.g., signal 25 based on the request, the response signal indicating that the device will operate in accordance with the request; and/or, e.g., in case where the device determines that the requested actions exceed the capabilities of the device or the current mode of operation, the response may indicate that the device will not operate in accordance with the request as described previously.

The device may be configured for variably storing the codebook/state/alphabet/LUT/register/list and for updating the codebook/state/alphabet/LUT/register/list responsive to a respective signal; and/or for storing the codebook/state/alphabet/LUT/register/list statically. That is, the codebooks/states/alphabets/LUTs/registers/lists may be implemented, e.g., by a manufacturer and may remain possibly unchanged over long periods of time but may also be set at the beginning of a specific test or operation mode. The device 10 may be configured for updating the codebook/state/alphabet/LUT/register/list at least at one of at a beginning of a measurement procedure; during a software update of a device manufacturer; and during a software update of a network provider.

The device 10 may be configured for forming the subset 15 whilst performing a localized beam sweeping, i.e., an orientation of at least a part (lobe and/or null) of the beam pattern may be modified so as to cause the beam pattern to move in space.

In other words, according to embodiments:

Option B: UE/device uses/applies a preconfigured state which covers an equivalent of localized or spherical coverage beam sweeping.
B1: the preconfigured state/alphabet/(spatial)/LookupTable/register/list codebook is known to the UE/device or/and programmed into the UE/device a priori of setting the FLAG/receiving a request to behave/act according to the FLAG.
B2: the preconfigured state/alphabet/(spatial) codebook/LookupTable/register/list can be set/configured by the ME/BS or any other entity communicating with the UE/device. Such preconfigured states have to be memorized by the device/UE over a substantial period of time—between the moment of setting/configuring the state/alphabet/(spatial) codebook/LookupTable/register/list and the moment of applying them.

With regard to Option B1, the preconfigured set of beams may be chosen as a response to e.g. the DL (downlink) measurement, a specific orientation of the UE or a specific spatial relationship of the device/UE and the ME/measurement antenna or with respect to a body or substance close to the device/UE e.g. a head.

With regard to Option B2, a duration of the periods of time may comprise a suitable amount of time, e.g., they may allow for a programming at the beginning of a measurement procedure that is recalled afterwards, to re-configure the device 10, e.g., during regular software updates by the manufacturer and/or in connection with a software update for a new/different/special wireless network and/or country/geographic region/resale market. For example, a chipset of the device 10 may be equipped with different configurations of panels and/or antennas or those might be distributed/located or aligned differently in the device 10. A codebook/state/alphabet/LUT/register/list may be understood as a combination of phase and amplitude values allowing a specific beam to be formed. The phase and amplitude values can be discrete or continuous, including analogue, digital beamforming and hybrid options.

In connection with such signalling capability and its application to a measurement procedure, embodiments may provide for the following UE capability:
1.) it CAN handle/respond to such command/FLAG with appropriate actions
   a. Can support/local beam sweeping in all directions of the sphere or
   b. Can support/local beam sweeping only in certain directions.
2.) UE CANNOT handle/respond to such command/FLAG with appropriate actions
   a. Cannot support/local beam sweeping at all

As the other embodiments described herein, the described concept related to the subset 15, i.e., selection of subsets of beam patterns with a predefined number is applicable for user equipment as well as for other devices such as for relays or base stations. Thus, the device may be a base station or a relay and the marking/identification of the beams are SSB (Synchronization Signal Block) or the like indicating a particular beam formed by the device.

The described aspect of having a limited subset with M beam patterns may also relate to:
1. The device (UE) may have the capability of doing localized beam sweep or not. This may be known or indirectly signaled without using a bit in the device capability register.
2. A tester, e.g., a measurement equipment/environment (ME), can set a Flag\Parameter to force a local beam sweep with M, e.g., 4 beam patterns being relatively small to minimize the number of SRS to be measured and does not need to be able to configure different M's. For example, to allow the testing of simple and low cost UEs that have limited beamforming capabilities, M may further be reduced. This comes at a cost of extra bits to signal the mode/state/M. Accordingly, a value of “m” may be chosen smaller than the maximum value of M
3. There may be a requirement of identifying a center/a direction/area around the local sweep to be performed based on the downlink measurement done by the UE/device e.g. using CSI-RS.

Embodiments may further relate to a localized beam sweeping that is identified as a method of overcoming a large number of M by setting it to the minimum needed e.g. M=4. In this way the number of SRS to be measured by the ME can be reduced and simple UEs as well as more complex are supported. This method allows an optimized beam correspondence assessment using localized beam sweeping which results in a reduction of measurement time/effort and a reduction of measurement uncertainty (MU) especially for UE/devices using larger antenna arrays exceeding 4 antenna elements capable of forming narrower beams.

A measurement procedure according to an embodiment, i.e., a method to evaluate a device may comprise, for example,
sending a stimulus signal to the device along a reception direction so as to stimulate the device to establish a link with a source of the stimulus signal;
receiving, from the device, a transmit beam pattern;
report, to the device, a quality measure of the transmit beam pattern;
selecting an area to be covered with during the testing and selecting a subset of beam patterns formable with the device so as to illuminate the area;
forming the subset of beam patterns; and
measuring the subset of beam patterns to evaluate the device.

In other words, such a procedure may comprise:

STEP1: Based on DL (downlink) signal an UL (uplink) beam is selected by the UE/device and its EIRP is measured by the measurement equipment (ME). Based on the DL measurement e.g. based on CSI-RS and further knowledge the area to be covered by the set of beams selected for the local beam sweeping is selected. For example, for selecting the UL beam the same UL beamforming coefficients (spatial filter) may be used as used for the DL beam.

STEP2: After this further beams are selected by the UE/device in order to provide a set of beams suitable for a local sweep covering a local area. The EIRPs of all beams belonging to the set of beams for the sweep are to be measured by the ME.

The predefined number of M may be a fixed value, e.g., set by the network. Alternatively, the value M may be a value that is variable. For example, the base station or a test equipment, e.g., the device 20 may indicate the value of M, e.g., by use of a suitable signal. Such a signal or a different signal may be used to indicate the area to be covered by the subset of beam patterns, e.g., depending on a specific test mode to be carried out or a specific opening angle to be obtained along one or more directions, e.g., so as to cover a base station in a specific distance. The selection of the area may be determined from a measurement, e.g., of the stimulus signal.

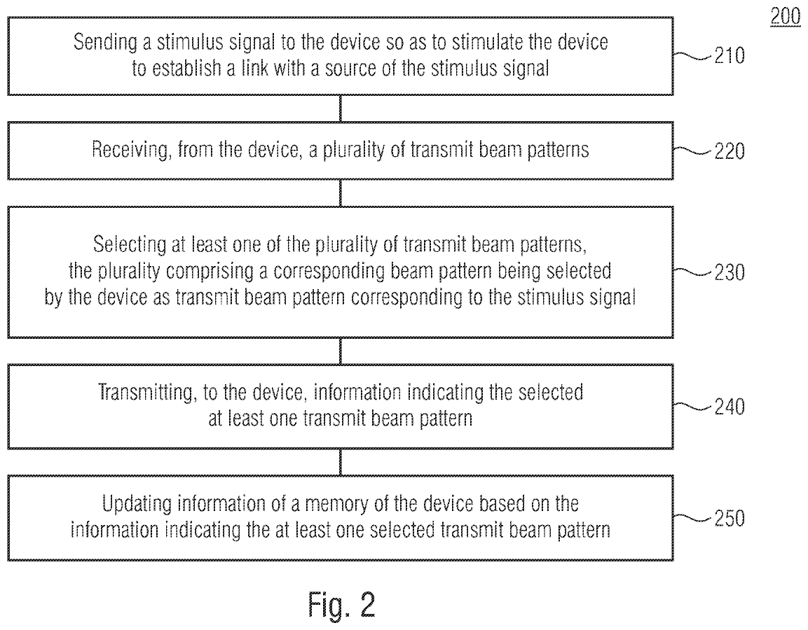

FIG. 2 shows a schematic flowchart of a method 200 for testing or updating a device, e.g., device 10. Method 200 comprises a step 210 in which a wireless stimulus signal is sent to the device, e.g., along a reception direction so as to stimulate the device to establish a link with a source of the stimulus signal along the reception direction. In a step 220, a plurality of beam patterns is received from the device, e.g., at the device 20. In a step 230, at least one of the plurality of beam patterns is selected. The plurality of beam patterns comprises a corresponding beam pattern being selected by the device as beam pattern corresponding to the stimulus signal. This selected beam pattern may be correctly or incorrectly be determined. A step 240 may comprise transmitting, to the device, information indicating the at least one selected beam pattern, e.g., the response information 24. The response information 24 may be in accordance with the selection made by the device 10 but may also deviate therefrom. A step 250 may comprise updating information of a memory of the device based on the information indicating the at least one selected beam pattern so as to modify a future selection of the corresponding beam pattern. This step may be optional as being possibly unnecessary when the selection information is in accordance with the selection made by the device 10, i.e., no relevant error occurs.

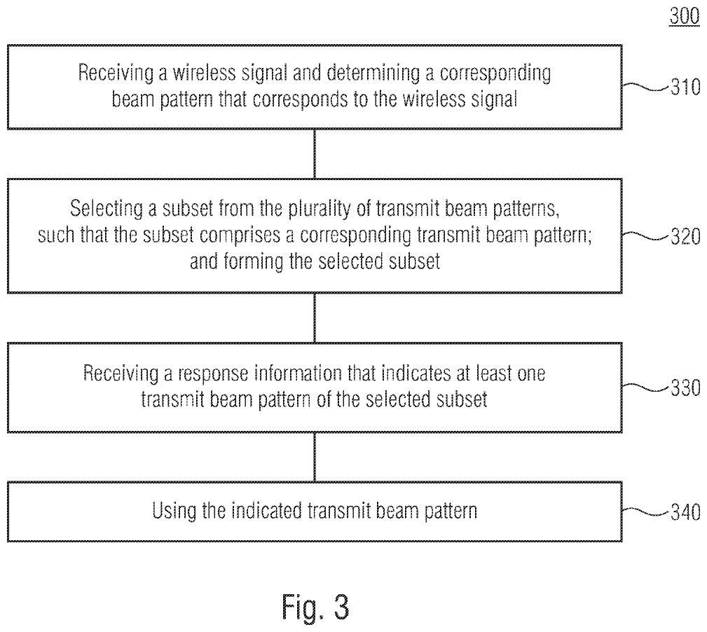

FIG. 3 shows a schematic flowchart of a method 300 according to an embodiment that may be used to operate a device, e.g., the device 10. Method 300 comprises a step 310 comprising receiving a wireless reception signal and determining a corresponding beam pattern that corresponds to the wireless signal, e.g., to a receive beam used for receiving the signal. A step 320 comprises selecting a subset from the plurality of beam patterns that may be generated, such that the subset comprises a corresponding beam pattern that comprises a main direction that corresponds to the reception direction. The selected subset is formed, by possibly sequentially being formed by the beam patterns of the subset. A step 330 comprises receiving a response information that indicates one beam pattern of the selected subset. A step 340 comprises using the indicated beam pattern, e.g., as corresponding beam pattern or to update a memory, e.g., a LUT.

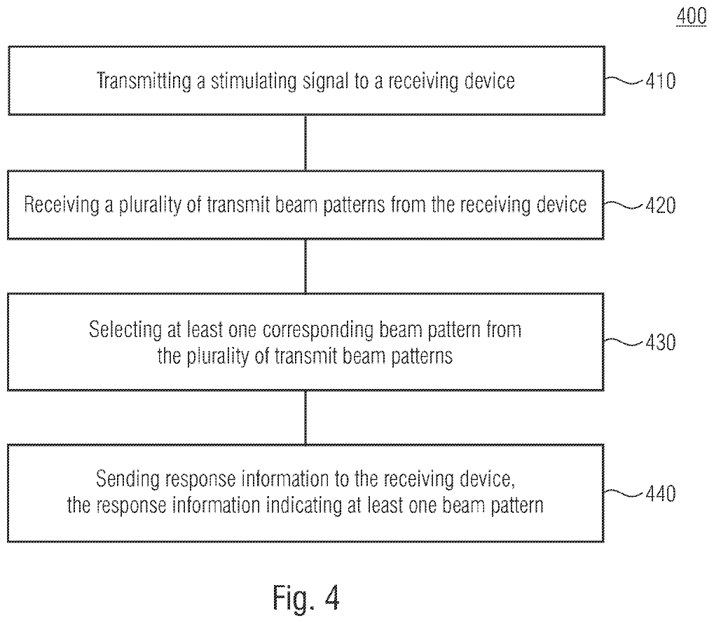

FIG. 4 shows a schematic flowchart of a method 400 that may be implemented to operate a device, e.g., the device 20. A step 410 comprises transmitting a wireless signal e.g., along a reception direction (including an omnidirectional transmission) to a receiving device, e.g., the device 10 which is a transceiving device based on the stimulated transmission of device 10. A step 420 comprises receiving a plurality of beam patterns from the receiving device. A step 430 comprises selecting a corresponding beam pattern from the plurality of beam patterns. A step 440 comprises sending response information to the receiving device, the response information indicating the corresponding beam pattern.

Examples described herein may be used in a variety of scenarios. One scenario is described by way of an example according to which due to the variability of the use case, the interaction of the user's body with the device may result in a pattern of the receive beam and the uplink beam due to, e.g., different panels used for reception and transmission. Embodiments allow to enable or even force the UE to produce an appropriate set of beams providing full or at least sufficient link coverage within a needed zone. The SS or gNB (in live operation) can assist the UE to learn about the best or at least a better corresponding beam in a given setup/radio propagation environment. The signal/signal variance in the link direction may fulfill a predefined range, e.g., within 20 dB, 15 dB, 10 dB or 5 dB. That may include main lobes, split beams and side lobes. According to an embodiment, the selected beam patterns to be part of the subset may contain only main lobes into the link direction. That may be obtained by selecting only those beam patterns that have their main lobe being arranged along the link direction (i.e., the main lobe at least partially directs towards the link direction). Embodiments are directed to a UE that comprises means of selecting a set of beams needed for a localized beam sweep. The localized beam sweep may be performed in and around a given direction having the meaning of a radio link. Whilst known devices are implemented to select a corresponding beam, embodiments allow to verify this selection so as to obtain a best beam pattern, i.e., a beam pattern that comprises a high or even maximum matching.

Some of the previously described embodiments relate to adapting or correcting a choice or selection of a corresponding beam pattern that was made by the UE. According to other embodiments, there may be other reasons for changing the selection of the UE and/or to provide the UE with an updated or changed basis for deciding which transmission beam to use.

For example, the device 10 of FIG. 1a may provide the subset. But instead of indicating only one beam pattern with device 20, device 20 may also provide for a selection of at least two beam patterns of the subset, either based on an own decision or responsive to a request received from device 10. The selection may be made, for example, based on parameter information such as a key performance indicators (KPI). For example, given a set of receive beam patterns which together cover a larger area and where individual receive beams have a coverage overlap, the device 10 may define a set of transmit beams covering the same or almost the same or a larger area. Those beam patterns may be obtained/learned/defined a virtual path correspondence, meaning that a certain optimized trajectory through/along the receive beam spot/areas corresponds to a trajectory through/along the transmit beam spot/areas. The concept may be similar to a UE navigating in a cellular network, observing the signal strength of neighboring base stations (these are known by a neighborhood list—which in our case is equivalent to the subset of receive and transmit beam sets used) when several base stations are received with a certain ratio of power a handover (HO) from one serving base station would/can be triggered. In the same way by observing the received power using different receive beams the UE can decide smoothly/proactively/delayed when another transmit beam can be used/appears more suitable. This mechanism supports a more robust and fuzzy selection of corresponding transmit beams based on the observed evaluated receive beams signals.

For example, the response information received from device 20 may contain a decision, which beam patterns of the subset are identified as providing a sufficient link quality so as to allow the device 10 to select the beam pattern to be implemented on its own, e.g., based thereon which beam pattern has some kind of spatial margin or power margin. E.g., beam patterns that are more centrally arranged in an antenna panel or need less power may be advantageous. A more centralized beam pattern may allow, amongst other things, for a longer time between switching between antenna panels and thus to delay an antenna handover.

Alternatively or in addition, the response information may comprise an order or sequence of beam patterns, e.g., a ranking or the like. Alternatively or in addition further information may be transmitted, e.g., KPI, wherein the device 20 may decide which information to be transmitted and/or the device 10 may request respective information. This concept may be combined without any limitation with an update of correspondence information.

Embodiments described herein may relate to correct to a correspond beam selection and/or to modify the selection, e.g., to provide a device with a selection which pattern to be used. Further embodiments relate to a device learns from its experience. For example, by learning that when the link was established in a certain direction relative to the device, and a set (subset) of beams was provided from which then a certain beam was then selected, that in the future when a link is requested in a similar direction relative to that which the device already has knowledge of (due to the learning/experience), then it returns a set of beams which are different to the set that it provided in its “early days of learning”, e.g., in a configuration after manufacturing. For example, a smaller subset of beams or a subset which introduces a beam that was not included before (in order to test the suitability of the beam and to test the ability of beam selection) may be used. Such information may be used in addition to the correspondence information, e.g., to weight single transmission beam patterns for a specific scenario and/or may directly be included into the correspondence information.

Further embodiments are related to a device that updates its correspondence information not only responsive to a signal that is transmitted to the device 10 so as to request providing the subset responsive to an attempt of the device to establish a link but alternatively or in addition responsive to a network or base station triggered event. For example, the device 20 may recognize or estimate that the device 10 is unused or unmoved, which may indicate that less or even no user interference may be expected and may autonomously trigger the update of the correspondence information by sending the stimulating signal. This may allow for compensating deviations from a state of device 10 that was a basis for programming or manufacturing the lookup tables of device 10 during manufacturing, e.g., a laboratory environment. Based on different covers, housings or modifications of device 10 its properties might have changed which may be compensated for by a network-side trigger of the update. That is, the device may be configured for using the indicated transmit beam pattern as corresponding beam pattern; and/or to adapt information indicating correspondence information that indicates associated transmission beam pattern

Further embodiments, that may be combined with other embodiments without limitation, recognize that a transmission beam pattern is not limited to a single beam pattern at a time. It is possible to implement also two or even more beam patterns at a time, each transmission beam pattern allowing to establishing and maintaining an distinct associated data connection. For example, long-range transmissions, e.g., to the moon, may implement different polarizations of beam patterns. But embodiments are neither limited to long-range transmissions nor to the polarization. Embodiments also relate to any range and any distinguishing property, e.g., different time, frequency, code, polarization, angular momentum or other spatial resources/dimensions.

Embodiments therefore relate to a device, e.g., device 10 that is capable of forming and maintaining multiple transmit beam patterns simultaneously. When providing the subset, the device may be configured for providing the transmit beam pattern together with an associated transmit beam pattern that is offered, to the node receiving the subset, as a pair or triplet, . . . of beams together with the transmit beam pattern. The response information may then indicate a respective pair, triplet, . . . of transmit beam patterns. In MIMO, the beam pairs are active at the same time. That is, beams of beam pairs are simultaneously transmitting (in MIMO mode).

In other words, some embodiments consider a device that provides a set of beams from which the “best” beam is then selected and used for subsequent purposes. That is, from a set of many beams, only one beam is chosen and then used later. An extension hereto considers the case when ultimately more than one beam is chosen and then used later. An example of this is in MIMO applications.

### Extensions of Embodiments Towards Multiple Beams

If UE/BS (Base Station)/IAB (Integrated Access and Backhaul Node) (the “device” 10) is using two or more beams then several beams have to be selected in combinations.
   This may indicate the need for “Multiple Beam (pair) Correspondence”
Applicable in the case of simultaneous multi-beam operation
   Depending on the channel and the supported MIMO mode (multipath diversity, multiplexing to one base station or to different base stations)
   The embodiments then cover a procedure that allows for individual beam marking per simultaneous beam
      SRS (Sounding Reference Symbols) may be orthogonal or quasi-orthogonal or of any other simultaneous SRS design; sounding reference symbols are one option to mark a specific beam
   The implementation of the procedure could be:
      Simultaneous, sequential or arbitrary (e.g. implemented by another entity that is present in the network)
   ID or SRS can be defined/applied per beam or per beam per panel

### Multi-Beam Correspondence Procedure

The device is estimating and/or selecting appropriate receive beams to achieve and/or support a given MIMO scheme and depending on these individual beams and their combination, selects pairs and/or combinations of beams which correspond to a transmit strategy for the UL
The device may provide a couple of beam combinations to be used as probing the UL in order to get response feedback from the SS or TE or gNB or other apparatus equipped for network operation
   Again, the beam pairs may follow the previous notion of targeting/pointing towards the direction of the other communication partner.
Considering certain metrics and thresholds a suitable beam pair (or higher order groups) may be selected and potentially stored in a LUT
   The LUT may consider certain beam pairs or beam combination exclusions specific to the antenna arrangements in the device or specifics of long term or short-term nature (reflections in the environment and user effects or temporarily mismatched antenna arrangements) in the propagation environment
The device might use an ordered procedure of selecting the beams—for example QR decompositions
   The beam combination may generally depend on the beam combinations at the gNB as well (a function of beam selection at gNB, antenna arrangements/panels and the UE and the propagation environment.)

The following considerations are relevant to the other embodiments:
Multiple beams can be implemented/applied in
   the same or different time, frequency, code, polarization, angular momentum or other spatial resources/dimensions.
Examples of beam identification
   SRS, different resource in a frame structure, which does not exclude the methods (slot, time based, modulation, coding, bandwidth, etc.)
Selection of beams forming a beam pair can be made:
   Individually/independent per beam
   Sequentially in an ordered or unordered manner
   Jointly
The overall transmission strategy between two communication devices using single user MIMO in diversity or multiplexing mode) can be optimized by optimizing the transmit beams at one side or on both sides, independently, iteratively or jointly.
   Even in MIMO diversity mode (single stream transmission) several receive and transmit beams (acting as virtual antennas in an effective MIMO system) can be used.
   A direct extension may be the support of Multi-user MIMO where the gNB supports multiple users/links simultaneously while per user only one link/stream is active/relevant.
      In Multiuser MIMO in particular in UL the beams of the UE have to be coordinated in space, time and frequency to facilitate spatial separation at the gNB.

With regard to the embodiments stated above, e.g., the QR decomposition, in a single user MIMO system, optimum capacity may be achieved, if the transmit and receive strategies and associated beamformers use Eigenmode beam forming, meaning that the beamformers feed into the dominant spatial Eigenmodes of the MIMO channel. On top a strategy called waterfilling is capacity achieving.

In an iterative approach, each end of the link can estimate the MIMO channel and does a QR decomposition. Next, it answers using the Q-Transpose before feeding into the MIMO channel. If done in an iterative manner, the two Qs at either end of the MIMO system become the input and output beamformers matching the fully orthogonal Eigenmodes of the MIMO channel.

The beam correspondence to a given wireless channel and a transmit strategy (beam former) used at the other end of the communication link should be answered by a corresponding beam pair fulfilling the Q-transpose criteria.

In this way, a two way beam formed single user MIMO system could converge to capacity achieving Eigenmode beamforming. But, since full reciprocity (pattern reciprocity) down to base band is hard to achieve in practice, embodiments propose offering several beam combinations, possibly marked with beam IDs/SRS which is a far more practical approach to tackle the problem. Furthermore, the space domain tracking of receive beams to corresponding transmit beams will be extended towards Eigenbeam tracking at one or at both ends of the wireless link.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

Depending on certain implementation requirements, embodiments of the invention can be implemented in hardware or in software. The implementation can be performed using a digital storage medium, for example a floppy disk, a DVD, a CD, a ROM, a PROM, an EPROM, an EEPROM or a FLASH memory, having electronically readable control signals stored thereon, which cooperate (or are capable of cooperating) with a programmable computer system such that the respective method is performed.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### REFERENCES

[1] RP-182879, “WF on Beam Correspondence”, Samsung, Apple, Nokia, Intel, ZTE, Sanechips, Qualcomm, MediaTek, Panasonic, Verizon, CATT, AT&T, OPPO, CMCC, Huawei, HiSilicon, CAICT, vivo, LG Electronics and KT Corp., RAN #82, Sorrento, Italy, 10-13 Dec. 2018.
[2] R4-1900278, “On uplink beam sweeping based EIRP test procedure”, Samsung and CAICT, RAN4 #92, Athens, Greece, 25 Feb.-1 Mar. 2019.
[3] R4-1902683, “WF on simulation assumptions for BC tolerance requirements”, LG Electronics, RAN4 #92, Athens, Greece, 25 Feb.-1 Mar. 2019.
[4] R4-1902683, “Draft CR to TR 38.810 in beam correspondence test procedure”, Samsung and Qualcomm, RAN4 #92, Athens, Greece, 25 Feb.-1 Mar. 2019.
[5] R4-1902252, “Ad-Hoc Meeting Minutes for Beam Correspondence”, Samsung, RAN4 #92, Athens, Greece, 25 Feb.-1 Mar. 2019.
[6] IEEE Standard for Definitions of Terms for Antennas, in IEEE Std 145-2013 (Revision of IEEE Std 145-1993), Mar. 6, 2014.
[7] IEEE Standard Test Procedures for Antennas, in ANSI/IEEE Std 149-1979, vol., no., pp. 0_1-, 1979, reaffirmed 1990, 2003, 2008.

1. A device for communicating in a wireless communication network, the device comprising an antenna arrangement, the device being configured for beamforming a plurality of transmit beam patterns using the antenna arrangement; wherein the device is configured for
receiving a wireless signal and for determining a corresponding beam pattern that corresponds to the wireless signal;
selecting a subset from the plurality of transmit beam patterns, the subset comprising the corresponding beam pattern; and for forming the selected subset; and
receiving a response information that indicates at least one transmit beam pattern of the selected subset; wherein the device is configured for using the indicated transmit beam pattern.

2. The device of claim 1, wherein the device is configured for using the indicated transmit beam pattern as corresponding beam pattern; and/or to adapt information indicating correspondence information that indicates associated transmission beam pattern.

3. The device according to claim 1, wherein the device comprises a memory having stored thereon correspondence information associating each of the plurality of transmit beam patterns with an associated reception beam pattern for receiving the wireless signal; wherein the device is configured for updating the correspondence information based on the response information so as to associate a different transmit beam pattern to the reception beam pattern.

4. The device according to claim 1, wherein the device is adapted so as to operate in a first mode and to form, in first mode responsive to the wireless signal, the corresponding beam pattern whilst not to form other beam patterns; wherein the device is configured for receiving a request signal indicating a request to form the subset, for switching into a second mode based on the request signal and for forming the subset in the second mode; and/or
wherein the device is configured for autonomously selecting and forming the subset of transmit beam patterns.

5. The device according to claim 1, wherein the device is configured for selecting the subset as a number of transmit beam patterns that comprise at least one of:
a transmission power towards or in the direction of a source of the wireless signal being above a threshold value; and
a location of a covering a region/zone or area of the transmit beam pattern with respect to the source of the wireless signal.

6. The device according to claim 1, wherein the device is configured to select the subset so as to exclude at least one transmit beam pattern from the plurality of transmit beam patterns from the subset based on an operational parameter of the device or on demand based on a received command signal or trigger signal.

7. The device according to claim 1, wherein the device is configured for selecting the subset so as to comprise a predefined number of beam patterns (M), and such that the (M) beam patterns of the subset are correlated to each other by a local variance of the main directions of their beam patterns.

8. The device according to claim 7, wherein the device is configured for selecting the subset such that the predefined number of M beam patterns locally covers an area around the corresponding beam pattern.

9. The device according to claim 7, wherein the device is configured for selecting the subset such that the predefined number of M beam patterns has a maximum density around the corresponding beam pattern.

10. The device according to claim 7, wherein the device is configured for selecting the subset such that the predefined number of beam patterns (M) are spread in a spreading area being at least a part of a sphere comprising an area illuminated by the corresponding beam pattern.

11. The device according to claim 10, wherein the device is configured for selecting the subset such that the predefined number is, within the capabilities of the device, uniformly distributed with the spreading area.

12. The device of claim 7, wherein the device is configured for selecting the subset so as to comprise exactly the predefined number of M beam patterns, the predefined number being advantageously 8.

13. The device of claim 7, wherein the device is configured for signaling information indicating that a number of selected beam patterns considered as candidates for the subset exceeds the predefined number M.

14. The device according to claim 13, wherein the subset is a first subset, wherein the device is configured for receiving, responsive to signaling the information indicating that a number of selected beam patterns considered as candidates for the subset exceeds the predefined number M, a signal indicating a request to form at least a second subset and for selecting and forming at least the second subset comprising at least one different beam pattern when compared to the first set of beam patterns.

15. The device of claim 14, wherein the device is configured for selecting the second subset such that beam patterns of the first and second subset cover at least partially a different area of a sphere around the device.

16. The device of claim 14, wherein the device is configured for selecting subsequent subsets, each subset comprised of a maximum of M beam patterns.

17. The device of claim 16, wherein the beam patterns in each subset differ compared to the beam patterns in the previously selected subsets.

18. The device according to claim 1, wherein the device is configured for selecting the subset based on a preconfigured codebook/state/alphabet/LUT/register/list associating the corresponding beam pattern with at least one additional beam pattern.

19. The device according to claim 18, wherein the codebook/state/alphabet/LUT/register/list associates the corresponding beam pattern with a number of beam patterns summing up together with the corresponding beam pattern to a predefined number of beam patterns, M.

20. The device according to claim 1, wherein the device is configured for forming the subset whilst performing a localized beam sweeping.

21. The device according to claim 1, wherein the device is configured for updating a lookup table indicating the plurality of transmit beam patterns based on user interaction information indicating a use of the device by a user.

22. The device according to claim 1, wherein the device is configured for updating a parameter setting relevant for an algorithm to determine the plurality of transmit beam patterns based on user interaction information indicating a use of the device by a user.

23. The device according to claim 1, wherein the device is configured for selecting the corresponding beam pattern based on a metric comparing the wireless signal with a plurality of predetermined values.

24. The device of claim 1 comprising a multitude of antenna arrangements or antenna panels to be used for transmission and/or reception.

25. The device according to claim 1, wherein the subset comprises the corresponding beam pattern and at least one additional beam pattern.

26. The device according to claim 1, wherein the subset comprises the corresponding beam pattern and at least one additional beam pattern, wherein the additional beam pattern provides signal power towards a source of the stimulus signal above a threshold and/or within a tolerance range.

27. The device according to claim 1, wherein the device is configured for labeling or identifying each transmit beam pattern of the subset individually.

28. The device of claim 1, wherein the device is configured for receiving response information that indicates at least two transmit beam patterns from the subset of transmit beam patterns, wherein the device is configured for selecting one of the transmit beam patterns indicated in the response information as a/the transmit beam pattern for establishing a link.

29. The device of claim 1, wherein the device is configured for receiving the wireless signal responsive to an attempt of the device to establish a connection; or by an event initiated by the wireless network.

30. The device of claim 1, wherein the device is configured for Multiple Input Multiple Output (MIMO) and for providing the subset so as to comprise at least pairs of simultaneously formed transmit beam patterns; and to receive response information that indicates at least one of the at least pairs.

31. A device configured for
transmitting a stimulating signal towards a transceiving device;
receiving a plurality of transmit beam patterns from the transceiving device;
selecting a corresponding beam pattern from the plurality of transmit beam patterns; and
sending response information to the receiving device, the response information indicating the corresponding beam pattern.

32. The device of claim 31, wherein the device is configured for selecting the corresponding beam pattern based on received signal powers from each of the transmit beam patterns of the plurality of transmit beam patterns.

33. The device of claim 31, wherein the device is configured for
receiving, responsive to the stimulating signal, a first transmit beam pattern;
transmitting a request signal to the transceiving device, the request signal indicating a request to the transceiving device to form the plurality of transmit beam patterns; and
for receiving the plurality of transmit beam patterns responsive to the request signal.

34. The device of claim 31, wherein the device is configured for evaluating at least one transmit beam pattern from the plurality of transmit beam patterns; and for sending information representing performance indicators or ranked orders according to metrics/criteria to the transceiving device, the information indicating the corresponding beam pattern to be chosen or input for choosing/selecting the corresponding beam patterns and/or the subset of transmit beams at the transceiving device.

35. The device of claim 31, wherein the device is configured for transmitting the response information so as to indicate at least two transmit beam patterns.

36. The device of claim 31, wherein the device is configured for autonomously sending the stimulating signal.

37. The device of claim 31, wherein the device is configured for Multiple Input Multiple Output (MIMO) and for receiving the subset so as to comprise at least pairs of transmit beam patterns; and to transmit response information that indicates at least one of the at least pairs.

38. A system comprising:
at least one device for communicating in a wireless communication network, the device comprising an antenna arrangement, the device being configured for beamforming a plurality of transmit beam patterns using the antenna arrangement; wherein the device is configured for
receiving a wireless signal and for determining a corresponding beam pattern that corresponds to the wireless signal;
selecting a subset from the plurality of transmit beam patterns, the subset comprising the corresponding beam pattern; and for forming the selected subset; and
receiving a response information that indicates at least one transmit beam pattern of the selected subset; wherein the device is configured for using the indicated transmit beam pattern; and
at least one device configured for
transmitting a stimulating signal towards a transceiving device;
receiving a plurality of transmit beam patterns from the transceiving device;
selecting a corresponding beam pattern from the plurality of transmit beam patterns; and
sending response information to the receiving device, the response information indicating the corresponding beam pattern.

39. The system according to claim 38, wherein the system is a measurement environment or a wireless communication network or a wireless communication system.

40. Method for operating a device comprising an antenna arrangement, the device being configured for beamforming a plurality of transmit beam patterns using the antenna arrangement, the method comprising:
receiving a wireless signal and determining a corresponding beam pattern that corresponds to the wireless signal;
selecting a subset from the plurality of transmit beam patterns, such that the subset comprises a corresponding transmit beam pattern; and forming the selected subset;
receiving a response information that indicates at least one transmit beam pattern of the selected subset; and
using the indicated transmit beam pattern.

41. Method for testing or updating a device comprising an antenna arrangement, the method comprising:
sending a stimulus signal to the device along a reception direction so as to stimulate the device to establish a link with a source of the stimulus signal;
receiving, from the device, a plurality of transmit beam patterns;
selecting at least one of the plurality of transmit beam patterns, the plurality comprising a corresponding transmit beam pattern being selected by the device as transmit beam pattern corresponding to the stimulus signal;
transmitting, to the device, information indicating the selected at least one transmit beam pattern; and
updating information of a memory of the device based on the information indicating the at least one selected transmit beam pattern.

42. The method of claim 41, wherein the transmitting of the information indicating the selected at least one transmit beam pattern comprises referring to a beam-ID or SRS associated with the transmit beam pattern.

43. Method for testing or updating a device comprising an antenna arrangement, the method comprising:
sending a stimulus signal to the device along a reception direction so as to stimulate the device to establish a link with a source of the stimulus signal;
receiving, from the device, a transmit beam pattern;
report, to the device, a quality measure of the transmit beam pattern;
selecting an area to be covered with during the testing and selecting a subset of beam patterns formable with the device so as to illuminate the area;
forming the subset of beam patterns; and
measuring the subset of beam patterns to evaluate the device.

44. The method of claim 43, wherein the selection of the area is determined from a measurement of the stimulus signal.
